(19) United States
(12) Patent Application Publication
(10) Pub. No.: US 2014/0218250 A1
(43) Pub. Date: Aug. 7, 2014

(54) CASE AND ELECTRONIC APPARATUS

(71) Applicant: Samsung Electronics Co., Ltd, Suwon-si (KR)

(72) Inventors: Tae-young KIM, Suwon-si (KR); Chee-hwan YANG, Yongin-si (KR); In-young LEE, Hwaseong-si (KR); Sang-hoon CHOI, Suwon-si (KR)

(73) Assignee: Samsung Electronics Co., Ltd, Suwon-si (KR)

(21) Appl. No.: 14/083,920

(22) Filed: Nov. 19, 2013

Related U.S. Application Data
(60) Provisional application No. 61/760,229, filed on Feb. 4, 2013.

(30) Foreign Application Priority Data
May 30, 2013 (KR) 10-2013-0062156

(51) Int. Cl. H01Q 13/10

(52) U.S. Cl. CPC H01Q 13/106
USPC 343/767

(57) ABSTRACT

An electronic apparatus includes a metallic case including an antenna pattern formed on an area of the metallic case where two sides surfaces of the case meet, the antenna pattern forming a slit antenna including a slit connecting one side of the antenna pattern to an open area of the metallic case, and a circuit board configured to process signals received at the antenna pattern.

### CROSS-REFERENCE TO RELATED APPLICATIONS

This application claims priority under 35 U.S.C. §119 from U.S. Provisional Patent Application No. 61/760,229, filed on Feb. 4, 2013 in the United States Patent and Trademark Office, and Korean Patent Application No. 10-2013-0062156, filed on May 30, 2013 in the Korean Intellectual Property Office, the disclosure of which is incorporated herein by reference in its entirety.

### BACKGROUND OF THE INVENTION

1. Field of the Invention

Cases and apparatuses consistent with the present general inventive concept as disclosed herein relate to a case and an electronic apparatus configured to use a metallic case of the electronic device as an antenna.

2. Description of the Related Art

With technological development, trends regarding functions of electronic apparatuses have become complicated and high-performance. Thus, a required number of units and antennas has increased, as functions of electronic apparatuses become more complicated and high-performance.

However, considering the fact that slimness and miniaturization of electronic apparatuses are also desired in order to enhance their mobility of, a method of providing an increased number of antennas on a smaller area is necessary.

Further, since a metallic case is frequently used in electronic apparatuses in order to enhance design and durability, the metallic case can affect the radiating of antennas.

Thus, the recent suggestion is to mount antennas on an area where a certain portion of the metallic case is removed. However, this may cause a disadvantage in view of design, when electronic apparatuses are implemented as described above. Therefore, a method of efficiently implementing antennas on electronic apparatuses is desired.

### SUMMARY OF THE INVENTION

Exemplary embodiments of the present general inventive concept provide a case in which a metallic case of an electronic apparatus can be used for antenna and the electronic apparatus.

Additional features and utilities of the present general inventive concept will be set forth in part in the description which follows and, in part, will be obvious from the description, or may be learned by practice of the general inventive concept.

Exemplary embodiments of the present general inventive concept provide an electronic apparatus which includes a metallic case including an antenna pattern formed on an area of the metallic case where two side surfaces of the case meet, the antenna pattern forming a slit antenna including a slit connecting one side of the antenna pattern to an open area of the metallic case, and a circuit board configured to process signals received at the antenna pattern.

The slit antenna may resonate on a 2 GHz bandwidth.

The slit antenna may be an L-shaped slit antenna.

The antenna pattern may include a groove area, which is formed on the area of the metallic case where the two side surfaces of the metallic case meet, and which is a cutaway area connected at one side to the open area of the metallic case, a first case area formed at an inner portion of the case and on one side with reference to the groove area, and a second case area formed at an outer portion of the case and on an opposite side from the first case area with reference to the groove area.

The groove area may have a width of at least 1 mm.

Width between the groove area and the open area of the metallic case may be at least 2 mm.

The groove area may be bent at least once.

The groove area may include a first groove area, which is formed in a vertical direction toward the open area of the metallic case, and which is cut so that one side thereof is connected to the open area of the metallic case, and a second groove area, which is formed in a horizontal direction toward the first groove area, and which is cut so that one side thereof is connected to the first groove area.

The second groove area may have a meander shape.

The length of the second groove area may be one-fourth of a wavelength on a first bandwidth.

The electronic apparatus may additionally include a connector configured to contact the antenna pattern, and to connect the antenna pattern to the circuit board.

The connector may be placed on an end of an area where the first case area and the second case area meet.

The connector may include an electrical feeder configured to contact the first case area and to electrically feed to the antenna pattern, a first ground configured to contact the second case area, a first terminal configured to electrically connect the electrical feeder and the circuit board, and a second terminal configured to connect the first ground to a ground of the circuit board.

The connector may additionally include a matcher disposed between the electrical feeder and the first terminal, to match an impedance of the antenna pattern.

The matcher may operate to match the impedance by using one of an L-shaped matching circuit, a 7-shaped matching circuit, and a T-shaped matching circuit.

The connector may additionally include an antenna pattern configured to resonate on a second bandwidth.

The electronic apparatus may additionally include a protector configured to fill in the groove area with an insulating material.

The electronic apparatus may additionally include a protector configured to fill in a portion of the antenna pattern with an insulating material.

The metallic case may include a plurality of antenna patterns.

The antenna pattern may be a slit antenna resonating on first and second bandwidths.

The first bandwidth may be 2 GHz bandwidth, and the second bandwidth may be 5 GHz bandwidth.

The antenna pattern may include a third groove area, which is formed on the area of the metallic case where the two side surfaces of the metallic case meet, and which is cut so that one side thereof is connected to the open area of the metallic case, a fourth groove area, which is formed at an inner portion of the case and on one side with reference to the third groove area, and which is cut so that one side thereof is connected to the open area of the metallic case, a third case area between the third groove area and the fourth groove area, a fourth case area formed at the inner portion of the case with reference to the fourth groove area, and a fifth case area formed at an outer portion of the case with reference to the third groove area.

The metallic case may be configured to protect a display apparatus.

The antenna pattern may be formed on at least one edge area between two edge areas on a lower end of the display apparatus.

Exemplary embodiments of the present general inventive concept also provide a metallic case covering an electronic apparatus, the metallic case including an antenna pattern operating as a slit antenna formed on an area of the metallic case where two side surfaces of the metallic case meet.

Exemplary embodiments of the present general inventive concept also provide an electrically conductive case, the case including a first side, a second side extended from the first side and disposed to have an angle with the first side, and an antenna pattern, including a groove area extending from the first side of the case to the second side, across a point where the first side and the second side meet.

The antenna pattern may resonate on a first bandwidth. The antenna pattern may further include an extender including a conductive strip bent towards an inner portion of the case, the extender having a length equal to one-fourth of a wavelength on a second bandwidth.

Exemplary embodiments of the present general inventive concept also provide an electrically conductive case of an electronic apparatus, the case including two opposing sides, a side disposed between the two opposing sides and extended along corners of the two opposing sides, and an antenna pattern formed on the side disposed between the two opposing sides and having a groove extended along a corner of the two opposing sides.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of an electronic apparatus according to an exemplary embodiment of the present general inventive concept;

FIG. 2 illustrates a case of the electronic apparatus of FIG. 1 according to an exemplary embodiment of the present general inventive concept;

FIG. 3 illustrates an example of an antenna pattern according to an exemplary embodiment of the present general inventive concept,

FIG. 4 illustrates an example of implementing the antenna pattern of FIG. 3;

FIG. 5 illustrates a protector of an antenna according to an exemplary embodiment of the present general inventive concept;

FIG. 6 illustrates a protector of an antenna according to an exemplary embodiment of the present general inventive concept;

FIGS. 7A-7C illustrate an antenna formed with an antenna pattern on a side surface and a radiating pattern according to an exemplary embodiment of the present general inventive concept;

FIG. 8 illustrates the radiating pattern of the antenna pattern of FIG. 3;

FIG. 9 illustrates an example of an antenna pattern according to an exemplary embodiment of the present general inventive concept;

FIG. 10 illustrates an example of implementing the antenna pattern of FIG. 9;

FIG. 11 illustrates an example of a radiating pattern in the antenna pattern of FIG. 9;

FIG. 12 illustrates an example of implementing the antenna pattern according to an exemplary embodiment of the present general inventive concept;

FIG. 13 illustrates an example of an antenna pattern according to an exemplary embodiment of the present general inventive concept;

FIG. 14 illustrates features in bandwidths of the antenna pattern of FIG. 13;

FIG. 15 illustrates radiating patterns of the antenna pattern of FIG. 13;

FIG. 16 illustrates an example of an antenna pattern according to an exemplary embodiment of the present general inventive concept;

FIG. 17 illustrates a constitution of a connector according to an exemplary embodiment of the present general inventive concept;

FIG. 18 illustrates an example of implementing the connector of FIG. 17;

FIG. 19 illustrates a constitution of a connector according to an exemplary embodiment of the present general inventive concept;

FIG. 20 illustrates an example of implementing the connector of FIG. 19;

FIG. 21 illustrates a constitution of a connector according to an exemplary embodiment of the present general inventive concept;

FIG. 22 illustrates a constitution of a connector according to an exemplary embodiment of the present general inventive concept;

FIG. 23 illustrates a constitution of a connector according to an exemplary embodiment of the present general inventive concept; and

FIG. 24 illustrates a constitution of a connector according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the following description, such as detailed construction and elements, are provided to assist in a comprehensive understanding of the present general inventive concept. Accordingly, it is apparent that the exemplary embodiments of the present general inventive concept can be carried out without those specifically defined matters. Also, well-known functions or constructions are not described in detail since they would obscure the present general inventive concept with unnecessary detail.

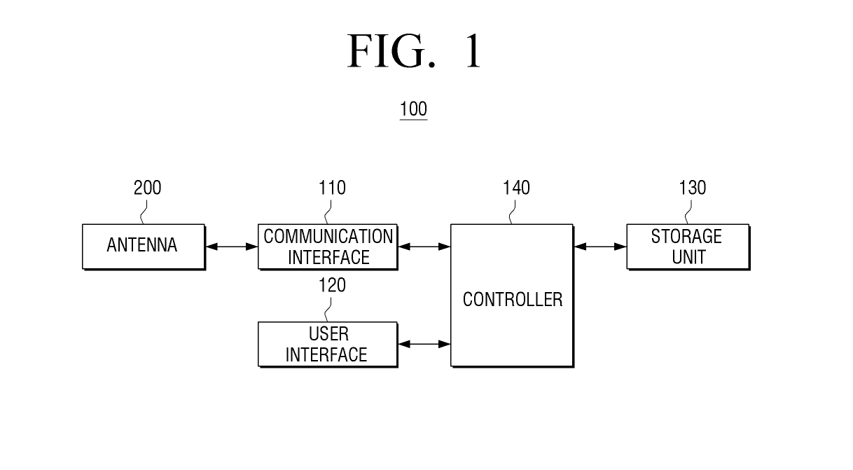

FIG. 1 is a block diagram of an electronic apparatus 100 according to an exemplary embodiment of the present general inventive concept.

Referring to FIG. 1, the electronic apparatus 100 according to an exemplary embodiment of the present general inventive concept includes a communication interface 110, a user interface 120, a storage unit 130, a controller 140, and an antenna 200. The electronic apparatus 100 performs communication with external devices such as a Personal Computer (PC), a laptop computer, a tablet PC, a Personal Media Player (PMP), or a smart phone, using the antenna 200.

The communication interface 110 is configured to connect the electronic apparatus 100 to an external device (not illustrated), and may connect according to wireless communication (e.g., GSM, UMTS, LTE, WiBRO, Wi-Fi, or Bluetooth) through the antenna 200 as well as connect to the external device through a near field communication network (local area network (LAN)) and internet network. Further, the communication interface 110 may connect to the external device and the internet network according to a plurality of wireless communication methods by using the antenna 200.

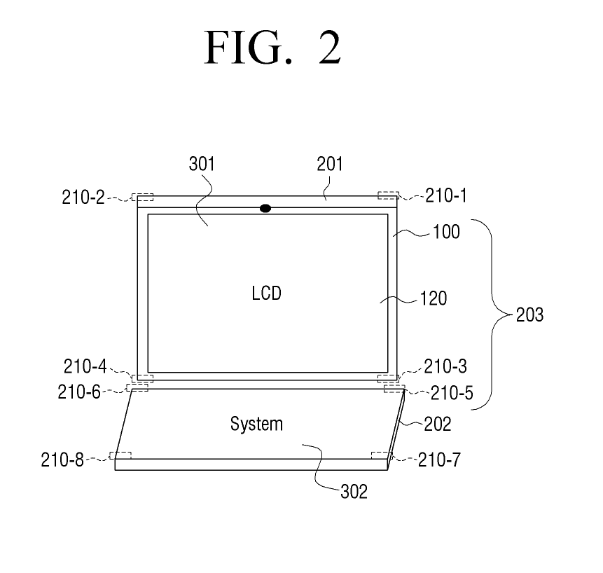

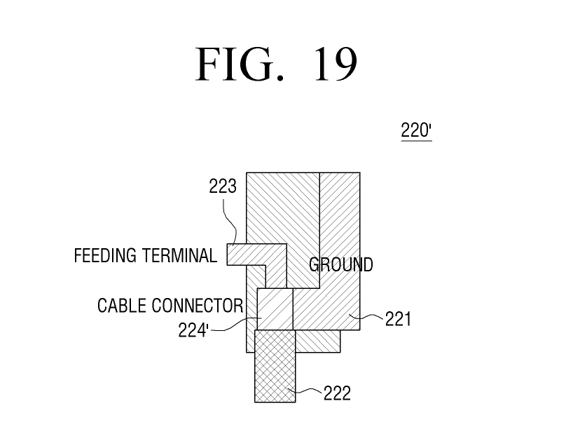

The communication interface 110 may include a circuit board (not illustrated) which is electrically connected to the antenna 200. The circuit board is electrically connected to an antenna pattern 210 (illustrated for example in FIG. 2) of the antenna 200 or an electrical feeder 223 (illustrated for example in FIG. 19), and provides electromagnetic energy to the antenna 200.

The antenna 200 radiates electronic waves by using electromagnetic energy provided from the circuit board. The antenna 200 according to an exemplary embodiment of the present general inventive concept may utilize a metallic case (203, illustrated for example in FIG. 2) by processing the metallic case 203 according to the antenna pattern 210. Specific shape and position of the antenna pattern 210 will be described below by referring to FIGS. 2 to 4.

The user interface 120 may include various function keys with which a user can establish or select various functions supported from the electronic apparatus 100, and may further display various information provided from the electronic apparatus 100. The user interface 120 may be implemented as a device which simultaneously performs input and output such as for example a touch screen, or a device combined with a mouse and a monitor (not illustrated).

The storage unit 130 stores programs to drive the electronic apparatus 100. Specifically, the storage unit 130 may store programs which are classes of various commands requested when in driving the electronic apparatus 100. Programs include a master boot record (MBR, or GPT) and an operating system (not illustrated).

The storage unit 130 may be implemented as a storing medium within the electronic apparatus 100 (e.g., a flash memory, a hard disk (HDD), and a solid state drive (SSD), not illustrated), a storing medium connected to an external storing medium (e.g., a removable disk including a USB memory and a host, not illustrated), and a web server through a network (not illustrated).

The controller 140 controls each unit within the electronic apparatus 100. Specifically, the controller 140 may determine operation mode of the electronic apparatus 100 by determining whether a user manipulates or not or how much time it passes after user manipulation.

Further, the controller 140 may control each component within the electronic apparatus 100 so as to be in an operating situation corresponding to a determined operation mode. Specifically, the electronic apparatus 100 may operate in a normal mode, one or more power-save modes, and an off mode. Herein, the normal mode is operation mode in which the electronic apparatus 100 performs a process requested from a user as the power is supplied to each component within the electronic apparatus 100, the power-save mode is one or more operation modes in which the electronic apparatus 100 cuts off or minimizes power provided to a specific component so as to minimize electrical energy consumed in the electronic apparatus 100, and the off mode is an operation mode in which the electronic apparatus 100 does not operate. For example, the controller 140 may cut off power to the antenna 200 in the power-save mode.

When a booting command is inputted, the controller 140 may perform booting by using the operating system stored in the storage unit 130. Further, the controller 140 may perform a corresponding function in response to a user command inputted through the user interface 120 after booting.

The electronic apparatus 100 according to exemplary embodiments of the present general inventive concept may perform communication with external devices by using the antenna 200 which will be described below. Thus, size of the electronic apparatus 100 can be reduced, and efficient communication can be encouraged.

FIG. 2 illustrates a case 203 of the electronic apparatus 100 of FIG. 1 according to an exemplary embodiment of the present general inventive concept.

Referring to FIG. 2, the case 203 covers the electronic apparatus 100 and may be formed from a metallic material. Although the case 203 is described as metallic in the following exemplary embodiments of the present general inventive concept, it will be understood that the case 203 is not so limited. The case 203 may be made of any electrically conductive material, depending on the configuration of a specific embodiment of the present general inventive concept.

The case 203 includes an antenna pattern 210 to operate as a slit antenna 200 formed on area where two side surfaces of the case 203 meet. Specifically, the antenna pattern 210 may be positioned on an area where two side surfaces (left-side surface, right-side surface, upper-side surface, or lower-side surface, to be specific) of the metallic case 203 meet. Herein, the “side surface” refers to surface which is adjacent to the largest side (a back face plate (not illustrated), for example) of the case 203.

For example, if the electronic apparatus 100 is a laptop computer as illustrated in FIG. 2, the case 203 of the electronic apparatus 100 may include a first case 201 to protect a display apparatus 301 and a second case 202 to protect an input apparatus 302, as illustrated in FIG. 2. The display apparatus 301 may be for example an LCD panel.

In this case, the antenna pattern 210 may be formed on areas 210-1, 210-2, 210-3, and 210-4 where two sides of the first case 201 meet, and areas 210-5, 210-6, 210-7, and 210- 8 where two sides of the second case 202 meet. In actual implementation, the antenna pattern 210 may be formed on one or a plurality of areas among the eight areas mentioned above and illustrated in FIG. 2.

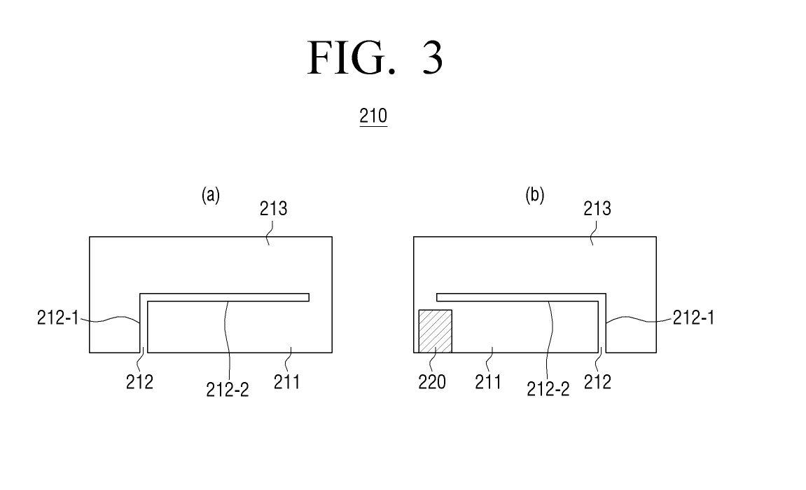

Meanwhile, when the antenna pattern 210 is positioned on lower areas 210-3 and 210-4 of the first case 201, the possibility that a user touches the antenna pattern 210 is lower, the antenna pattern 210 is not seen by a user who is watching the front of the electronic apparatus 100, and connecting the circuit board placed on the second case 202 to the antenna 200 becomes easier. However, when the distance between the display apparatus 301 and the first case 201 is not sufficient, the antenna pattern 210 may not be formed on the lower areas 210-3, 210-4 of the first case 201. Specifically, when the antenna pattern 210 should be connected to the circuit board through a connector 220 (illustrated for example in FIG. 3), there is not enough space for the connector 220 to be formed between display apparatus 301 and the case.

In this case, the antenna pattern 210 may be formed with a webcam (not illustrated) on the upper areas 210-1, 210-2 of the first case 201 where the distance between display apparatus 301 and the first case 201 is sufficient, or arranged on the lower areas 210-3, 210-4 of the first case 201 while certain area of the antenna pattern 210 is plated so that the antenna pattern 210 and the circuit board are connected to each other with soldering and without having to use the connector 220.

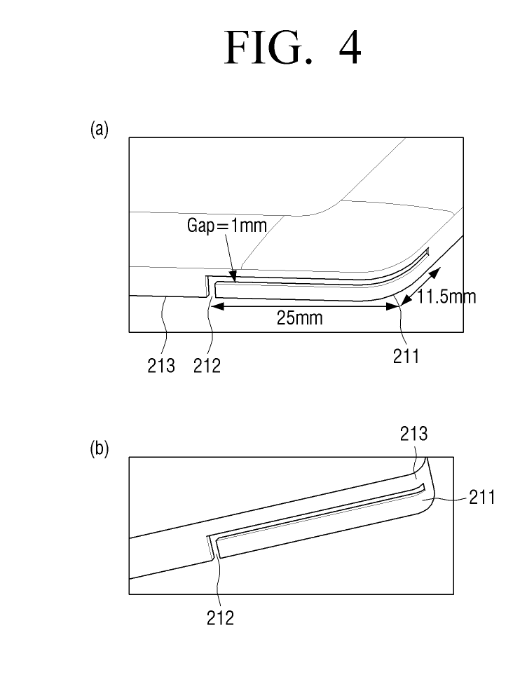

Meanwhile, when the antenna pattern 210 is formed on a plurality of areas, a resonating bandwidth of each antenna pattern 210 may be uniform (i.e., used as a multiple-input and multiple-output (MIMO) antenna), or may be implemented differently. Specific configurations of the antenna pattern 210 will be described below by referring to FIGS. 3 and 4.

Since the electronic apparatus 100 according to the above exemplary embodiment of the present general inventive concept has the antenna pattern 210 formed on the case, the size of the electronic apparatus 100 can be reduced. Further, because the antenna pattern 210 is formed on side area of the case 203 which is not visible during use of the electronic apparatus 100, detrimental influence on the design due to the placing of the antenna pattern 210 can be minimized.

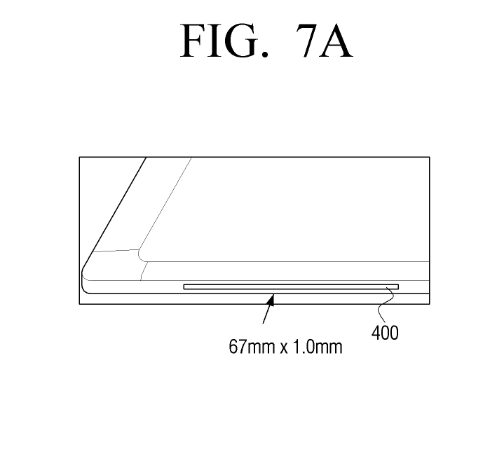

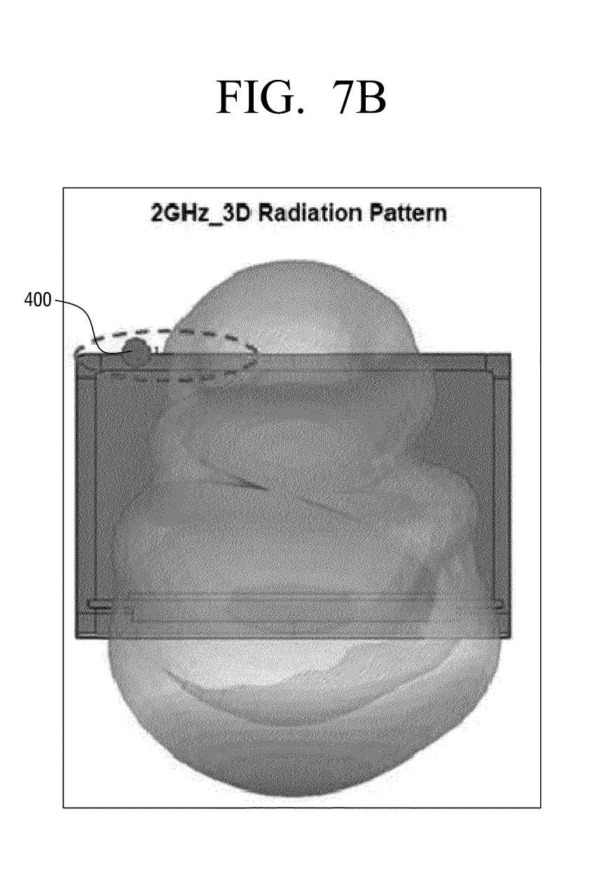

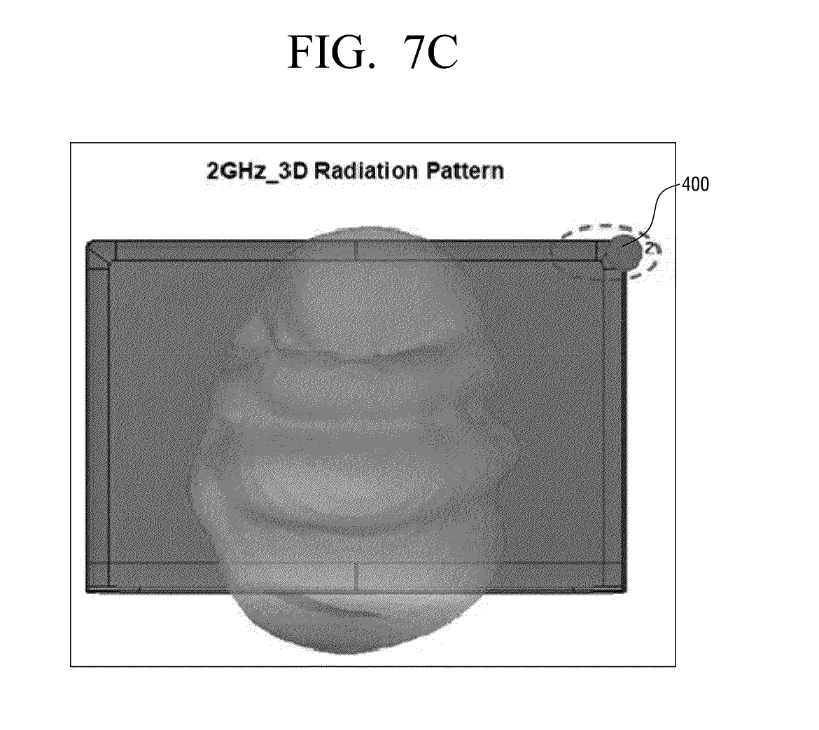

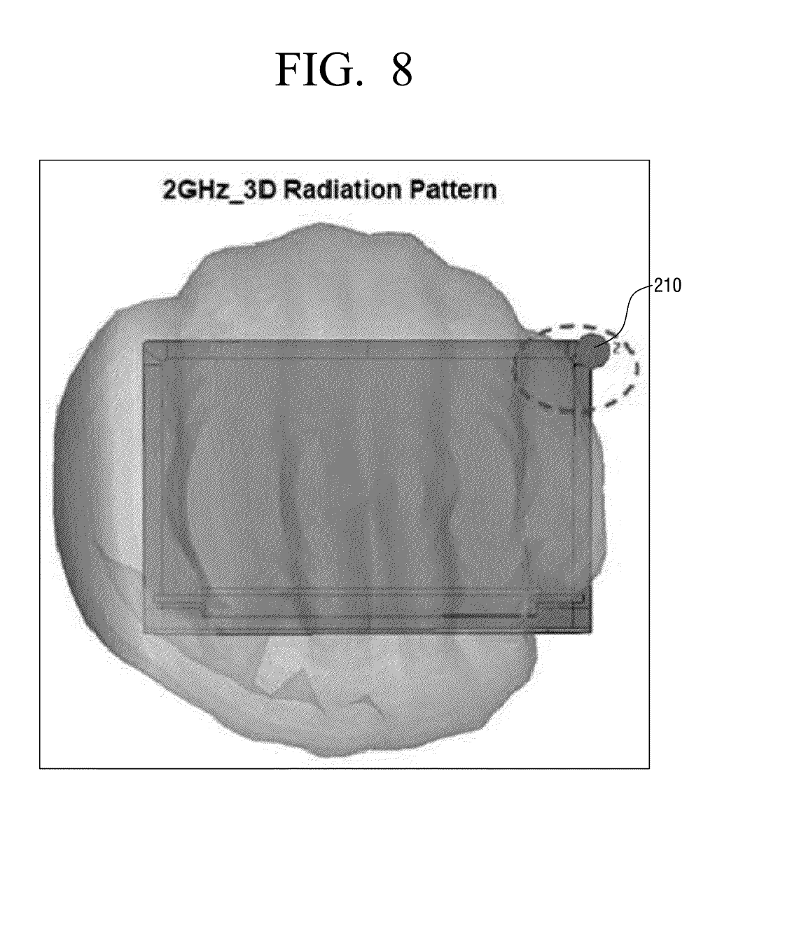

Further, because the antenna pattern 210 is formed on area where two sides of the case 203 meet, (i.e., on an edge area), a more efficient radiating pattern 210 may be obtained. Such effects will be described below by referring to FIGS. 7A-7C and 8. Further, because the antenna pattern 210 is implemented as slit antenna 200, a slimmer shape of the antenna 200 may be implemented.

Meanwhile, although FIG. 2 illustrates only an exemplary embodiment of the electronic apparatus 100 as a laptop computer, the antenna pattern 210 may be formed on any of four areas where two sides of one case 203 meet when the electronic apparatus 100 is tablet PC or smart phone which includes only one case 203.

Further, when the electronic apparatus 100 is a laptop computer with a first metal case 201, the antenna pattern 210 may be formed on four areas 210-1, 210-2, 210-3, and 210-4 where two sides of the first case 201 meet.

Meanwhile, in describing an exemplary embodiment of the present general inventive concept with reference to FIG. 2, the first case 201 covers a back face, left and right sides, upper and lower sides, and some area of the front face (or bezel) of the display apparatus 301; however, the first case 201 may be implemented to uncover some area of the front face, i.e., to cover just the back face, left and right sides, and upper and lower sides.

FIG. 3 illustrates an example of an antenna pattern 210 according to an exemplary embodiment of the present general inventive concept. Specifically, a view (a) of FIG. 3 illustrates a shape of the antenna pattern 210 viewed from above, and a view (b) of FIG. 3 illustrates shape of the antenna pattern 210 viewed from inside of the case 203. Further, FIG. 4 illustrates an example of implementing the antenna pattern 210 of FIG. 3. View (a) of FIG. 4 illustrates the shape of the antenna pattern 210 when viewed from outside of the case 203, and indicates sample dimensions of the components according to the exemplary embodiment of the present general inventive concept. View (b) of FIG. 4 illustrates the antenna pattern 210 when viewed from inside the case 203.

Referring to FIGS. 3 and 4, the antenna 200 includes the antenna pattern 210 and the connector 220.

The antenna pattern 210 is an L-shaped slit antenna 200 resonating on a first bandwidth. Herein, the first bandwidth is 2 GHz, although not strictly limited thereto. The slit antenna 200 includes a slit of which one side opens on the planar surface of the antenna 200, and has a radiating pattern caused by magnetic flow distribution. The L-shaped slit antenna 200 is used for the antenna pattern 210 in the exemplary embodiment illustrated in FIG. 3; however, in actual implementation, a slit antenna 200 with a different shape from the L-shape may be used.

Specifically, the antenna pattern 210 includes a groove area 212, a first case area 211, and a second case area 213.

The groove area 212 is formed as a portion of the case 203 is cut away, and is in an area where two sides of the case 203 meet (i.e., in edge area of the case 203). Such groove may have for example the width of at least 1 mm.

The groove area 212 may be bent at least once, as illustrated in FIGS. 3 and 4. Specifically, the groove area 212 may include a first groove area 212-1 and a second groove area 212-2.

The first groove area 212-1 is formed on a vertical direction regarding open area of the case 203, and cut so that one side can connect to the open area of the case 203. The width of the first groove area 212-1 is, for example, at least 1 mm, and the length of the first groove area 212-1 is, for example, at least 2 mm. Meanwhile, in actual implementation, a resonating bandwidth of the antenna pattern 210 may be tuned by adjusting the width or the length of the first groove area 212-1. This is specifically because the width of the first case area 211 is determined by the length of the first groove area 212-1, and the width of the first case area 211 affects resonating bandwidth.

The open area described above is the lower area illustrated in FIG. 3, and refers to the area which faces the largest area of the case 203 (i.e., front face, to be specific), or area where display apparatus 301 is placed, or area where a user stands.

The second groove area 212-2 is formed on a vertical direction toward the first groove area 212-1, and cut so that one side connects to the first groove area 212-1. The width of the second groove area 212-2 is, for example, at least 1 mm, and the length of the second groove area 212-2 may be one-fourth of the wavelength of the first bandwidth. Thus, the length of the second groove area 212-2 may be established so as to correspond to resonating bandwidth necessary for the antenna pattern 210.

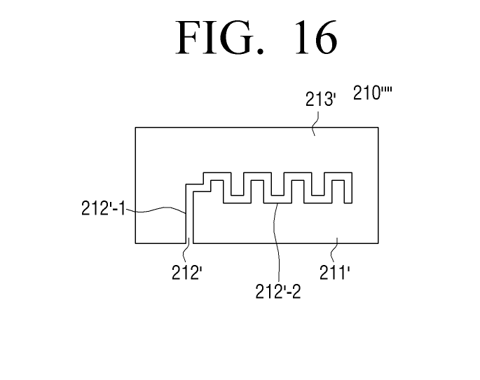

The second groove area 212-2 may be line-shaped as illustrated in FIG. 3, or meander-shaped as illustrated in FIG. 16, discussed below. Meanwhile, in certain exemplary embodiments of the present general inventive concept, the second groove area 212-2 may be formed on a vertical direction toward the first groove area 212-1. However, in actual implementation, the second groove area 212-2 and the first groove area 212-1 may be formed at an angle other than 90°.

With reference to the groove area, the first case area 211 is an internal case area, which receives electrical feeding from the circuit board. The width of the first case area 211 is for example 2 mm or above.

With reference to the groove area, the second case area 213 is an external case area, which is electrically connected to ground.

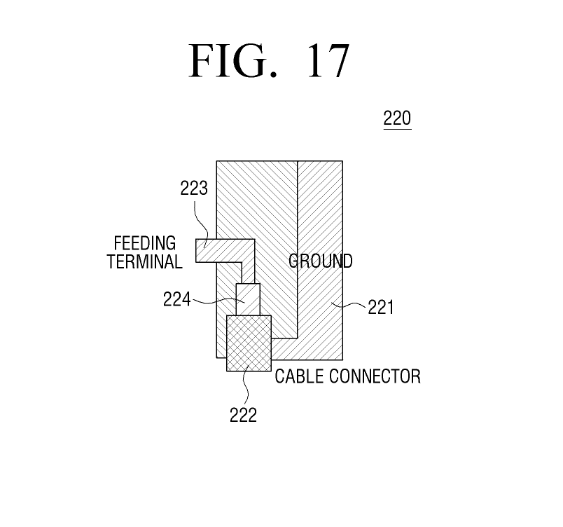

As illustrated in view (b) of FIG. 3, the connector 220 contacts the antenna pattern 210 in a contact method, and electrically connects the antenna pattern 210 and the circuit board. Specific configuration and operation of the connector 220 will be described below with reference to FIGS. 17 to 24. Meanwhile, the exemplary embodiment describes that the antenna pattern 210 and the circuit board connect by using the connector 220; however, in actual implementation, the antenna pattern 210 and the circuit board are electrically connected by plating a certain area of the antenna pattern 210 (gold-plating or silver-plating) and soldering the plated area without having to use the connector 220.

Meanwhile, FIG. 3 illustrates that the area where two sides of the case 203 meet may be an intersection of two flat planes; however, the area where the two sides meet may be curve- shaped, as illustrated in FIG. 4. Further, FIG. 3 illustrates that the two side surfaces of the case 203 are respectively directed toward upper and lower directions, thus forming the intersection of two flat planes illustrated in FIG. 3. However, the two sides may be bent toward upper and lower directions, thus forming the curve-shaped intersection illustrated in FIG. 4.

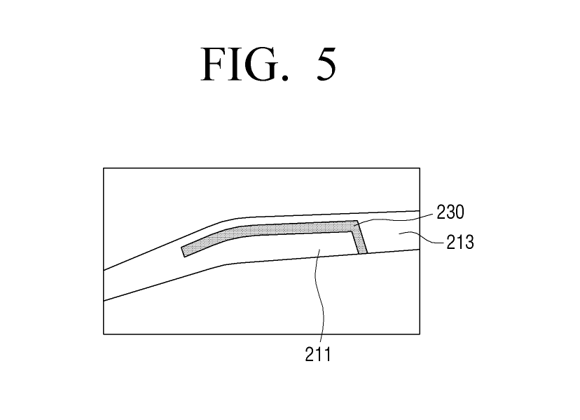

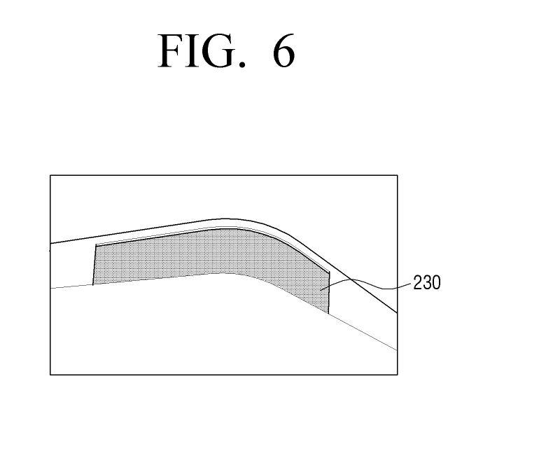

FIG. 5 illustrates a protector of an antenna 200 according to an exemplary embodiment of the present general inventive concept, and FIG. 6 also illustrates a protector of an antenna according to an exemplary embodiment of the present general inventive concept.

As illustrated in FIG. 4, because the antenna pattern 210 according to the exemplary embodiment of the present general inventive concept is formed by cutting the case 203, an inner area of the case 203 with reference to the groove area (i.e., the first case area 211) may be deformed by an impact on the case 203.

Thus, in order to prevent deformation of the antenna pattern 210 from such an impact, the electronic apparatus 100 according to the exemplary embodiment of the present general inventive concept may further be provided with the protector 230 which includes insulating material filling in the cutting groove as illustrated in FIG. 5, or the protector 230′ which is the insulating material attached to an upper portion of the antenna pattern 210, as illustrated in FIG. 6.

The following will describe the reason for forming the antenna pattern 210 according to the exemplary embodiment on an area where two sides meet and as a slit antenna 200 (L-shaped slit antenna 200), by referring to FIGS. 7A-7C and 8.

FIG. 7A illustrates a slot antenna pattern 400 is placed on the side surface in the case 203, away from where two sides meet. FIG. 7B illustrates a radiating pattern of the slot antenna pattern 400 of FIG. 7A, and FIG. 7C illustrates a radiating pattern when the slot antenna pattern 400 is placed on the area where two sides of the case 203 meet.

Referring to FIG. 7A, the antenna pattern 210 is the slot antenna pattern 400 having a predetermined length of a groove on one side of the case 203. It is clear that left and right radiating is suppressed with such a slot antenna pattern 400, as illustrated in FIG. 7B, in which the slot antenna pattern 400 is indicated by the dotted area.

Referring to FIG. 7C, when the position of the slot antenna pattern 400, indicated by the dotted area, is moved to the edge area, suppression of left and right radiating is somewhat improved. However, left and right radiating is still suppressed.

However, referring to FIG. 8, the L-shaped slit antenna pattern 210, indicated by the dotted area, formed on the area where two sides of the case 203 meet according to an exemplary embodiment of the present general inventive concept radiates omnidirectionally, and thus, it is clear that the directional problem is relieved.

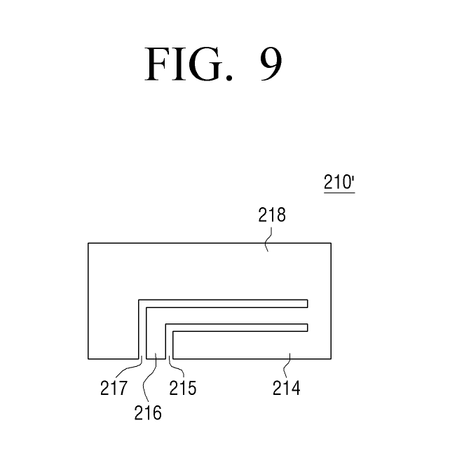

Meanwhile, although the above illustrates and describes that one antenna pattern 210 operates in one bandwidth, the antenna pattern 210 may be implemented to operate in a plurality of bandwidths. Such examples will be explained below by referring to FIGS. 9 to 16.

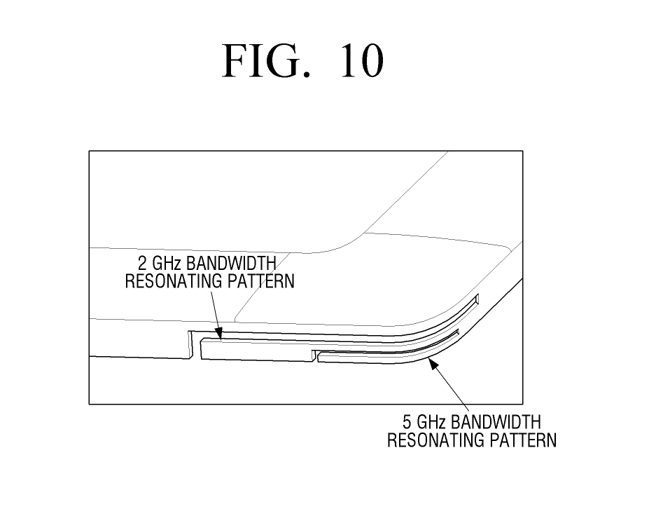

FIG. 9 illustrates an example of an antenna pattern 210′ according to an exemplary embodiment of the present general inventive concept, and FIG. 10 illustrates an example of implementing the antenna pattern 210′ of FIG. 9.

Referring to FIGS. 9 and 10, the antenna pattern 210′ according to the exemplary embodiment of the present general inventive concept is an L-shaped slit antenna 200 resonating in a first bandwidth and a second bandwidth. For the purposes of this exemplary embodiment, the first bandwidth is 2 GHz, and the second bandwidth is 5 GHz, although the first and second bandwidths are not limited thereto.

Specifically, the antenna pattern 210′ according to the exemplary embodiment of the present general inventive concept may include a third groove area 217, a fourth groove area 215, a third case area 216, a fourth case area 214, and a fifth case area 218.

The third groove area 217 is formed on the area where two sides of the case 203 meet, and is cut so that one side connects to the open area of the case 203. The third groove area 217 has a shape which is cut at least once, as illustrated in FIG. 9, and the width of the third groove area 217 is for example at least 1 mm. The function and constitution of the third groove area 217 are not described herein because they are the same as those of the groove area 212 in FIG. 3.

With reference to the third groove area 217, the fourth groove area 215 is formed at an inner portion of the case 203 and is a cutaway area with one side being connected to the open area of the case 203. The fourth groove area 215 has a shape which is cut at least once, as illustrated in FIG. 9, and the width of the fourth groove area 215 is for example at least 1 mm. The function and constitution of the fourth groove area 215 are not described herein because they are the same as those of the groove area 212 in FIG. 3.

The third case area 216 is a case area between inside of the third groove area 217 and outside of the fourth groove area 215, which receives first electrical feeding from the circuit board. The width of the third case area 216 is for example at least 2 mm.

The fourth case area 214 is an inner case area with reference to the fourth groove area 215, and it receives second electrical feeding from the circuit board. The width of the fourth case area 214 is for example at least 2 mm.

The fifth case area 218 is an outer case area with reference to the third groove area 217, and it is connected to the ground electrically.

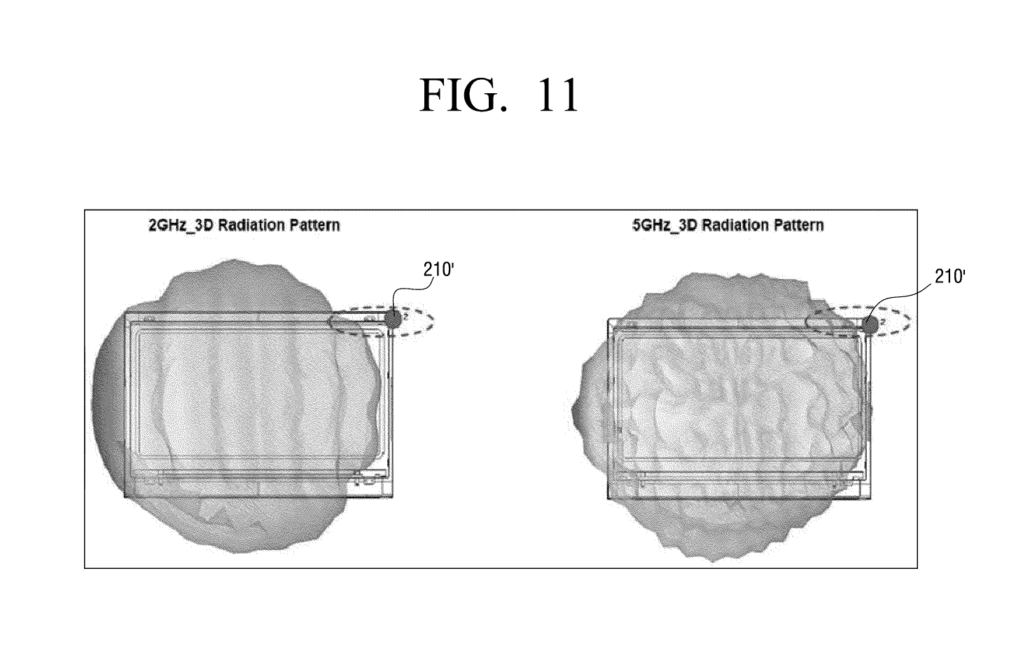

FIG. 11 illustrates a radiating pattern of the antenna pattern 210′ of FIG. 9. Specifically, view (a) of FIG. 11 illustrates a radiating pattern on a 2 GHz bandwidth, and view (b) of FIG. 11 illustrates a radiating pattern on a 5 GHz bandwidth.

Referring to FIG. 11, the antenna pattern 210′ of FIG. 9 according to the exemplary embodiment of the present general inventive concept, as indicated by the dotted areas, has omnidirectional antenna features because it radiates omnidirectionally on both 2 GHz and 5 GHz wavelengths.

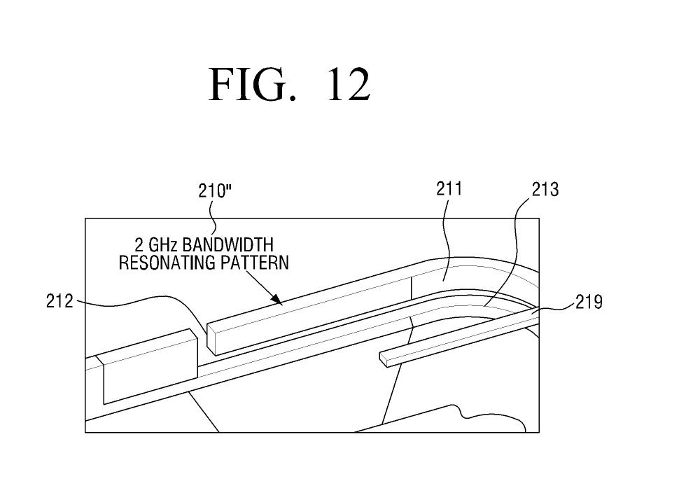

FIG. 12 illustrates an implementing example of an antenna pattern 210″ according to an exemplary embodiment of the present general inventive concept.

Referring to FIG. 12, the antenna pattern 210″ according to the exemplary embodiment of the present general inventive concept includes a groove area 212, a first case area 211, a second case area 213, and an extender 219. Herein, since the groove area 212, the first case area 211 and the second case area 213 are the same as the antenna pattern 210 of FIG. 3 in terms of function and operation, such will not be redundantly described below.

The extender 219 is a metal strip resonating on the second bandwidth. Specifically, the extender 219 may be generated while forming the groove area 212 of the antenna pattern 210″. The extender 219 may be generated by bending one end of the case 203 inwards, toward the electronic apparatus 100, instead of cutting the same when the groove area 212 of the antenna pattern 210″ is cut away. A total length of the metal strip regarding the extender 219 may be for example one-fourth of the wavelength on the second bandwidth.

Meanwhile, in certain exemplary embodiments of the present general inventive concept, the extender 219 may be formed by using the cutaway area of the groove area 212. However, in actual implementation, the extender 219 may be formed by compressing the metallic case 203 to divide the upper side from the side surfaces, and cutting the resting part except for the area where the extender 219 will be formed to match the thickness of the side of the case 203.

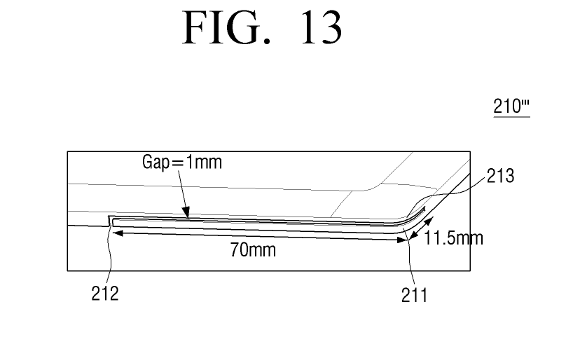

FIG. 13 illustrates an example of an antenna pattern 210″′ according to an exemplary embodiment of the present general inventive concept.

Referring to FIG. 13, the antenna pattern 210″′ according to the exemplary embodiment of the present general inventive concept is the same as the antenna pattern 210 of FIG. 3 in terms of constitution, except for a difference in the lengths of the groove area 212 and the first case area 211.

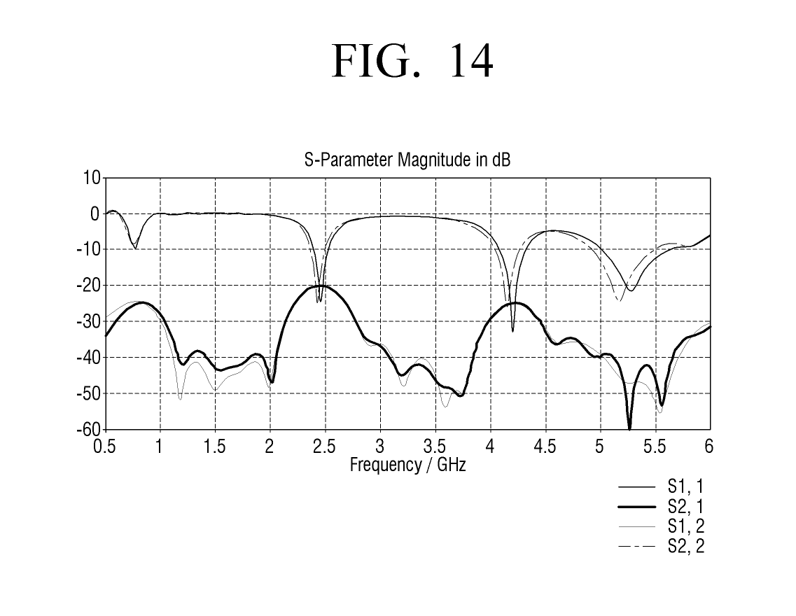

Specifically, the horizontal length of the groove area 212 (the length of the second groove area 212-2, to be specific) is about 81.5 mm, which is differently implemented from the exemplary embodiment of the present general inventive concept illustrated in FIG. 3. By implementing the horizontal length of the groove area 212 to be longer than that of FIG. 3, the antenna pattern 210″′ of FIG. 13 according to the exemplary embodiment of the present general inventive concept has bandwidth characteristics covering 800 MHz, 2.4 GHz bandwidth, 4.2 GHz bandwidth, and 5-6 GHz bandwidth, as illustrated in FIG. 14. Thus, the antenna pattern 210″′ according to the exemplary embodiment of the present general inventive concept illustrated in FIG. 13 may be applied as a multi band antenna by using the above characteristics.

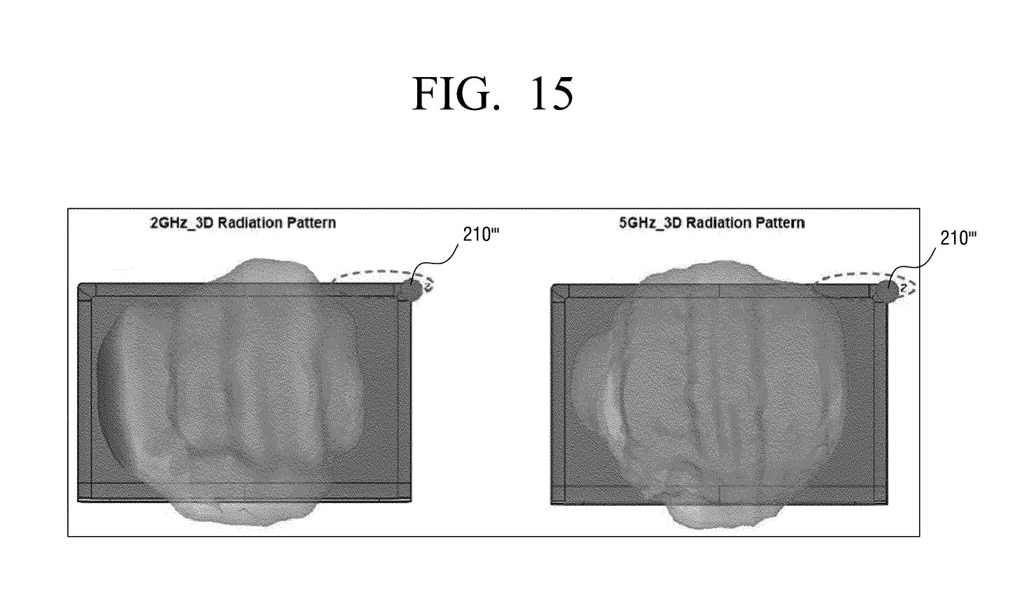

FIG. 14 illustrates bandwidth characteristics of the antenna pattern 210″′ of FIG. 13, and FIG. 15 illustrates radiating patterns of the antenna pattern 210″′ of FIG. 13, its location indicated by the dotted areas. View (a) of FIG. 15 illustrates the radiating pattern at a 2 GHz bandwidth, and view (b) of FIG. 15 illustrates the radiating pattern at a 5 GHz bandwidth.

Referring to FIGS. 14 and 15, by implementing the length of the first case area 211 to be longer, a multi band antenna may be implemented. Further, it is clear that the implemented antenna may have omnidirectional antenna features because of radiating omnidirectionally.

FIG. 16 illustrates an example of the antenna pattern 210″′ according to an exemplary embodiment of the present general inventive concept.

Referring to FIG. 16, the antenna pattern 210″′ according to the exemplary embodiment of the present general inventive concept is the same as the antenna pattern 210 according to first exemplary embodiment in terms of constitution, except for the different shape of the second groove area 212′-2.

Specifically, the exemplary embodiment of the present general inventive concept illustrated in FIG. 16 includes a first case area 211′, a second case area 213′, and a groove area 212′ having a first groove area 212′-1 and a second groove area 212′-2. As illustrated in FIG. 16, the second groove area 212′-2 has a meander shape. Thus, with the second groove area 212′-2 being meandered, it is possible to tune to second and third bandwidths, differently from the exemplary embodiment of the present general inventive concept illustrated in FIG. 13.

The following will explain the connector 220 which electrically feeds the antenna pattern 210 implemented according to the above methods. Specifically, because metal components such as aluminum or duraluminum cannot be directly soldered, soldering may be performed after plating a part of the surface in the metal case 203 described above (gold-plating or silver-plating), or a feeding structure in a contact method may be necessary. The following will explain the connector 220 having the feeding structure in the contact method by referring to FIGS. 17 to 24. Although antenna pattern 210 is referred to in the discussion of these drawings, it will be understood that the exemplary embodiments illustrated in FIGS. 17 to 24 may operate with any of the above-described exemplary embodiments of the antenna pattern 210, 210′, 210″, 210″′, or 210″″, or any other embodiment of the antenna pattern according to the present general inventive concept.

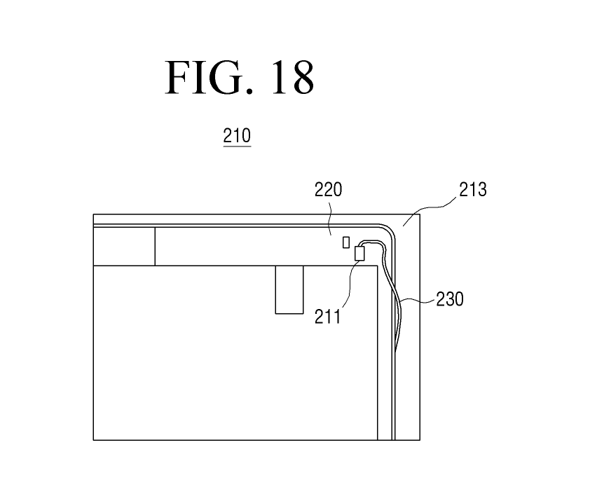

FIG. 17 illustrates a constitution of the connector 220 according to an exemplary embodiment of the present general inventive concept, and FIG. 18 illustrates an example of implementing the connector 220 of FIG. 17.

Referring to FIGS. 17 and 18, the connector 220 connects to the antenna pattern 210, and is formed on the lower end of the area where the first case area 211 and the second case area 213 meet. The connector 220 includes an electrical feeder 223, a first ground 221, a first terminal 224, and a second terminal 222.

The electrical feeder 223 contacts the first case area 211 in the contact method, and provides electrical feeding to the antenna pattern 210. The electrical feeder 223 is formed on the lower end of the first case area and performs electrical feeding to the first case area 211. In actual implementation, resonating frequency may be tuned by adjusting electrical feeding position of the electrical feeder 223 to the first case area 211. Specifically, on the lower end of the first case area 211, the electrical feeder 223 may be formed closer to or far from the area where the first case area 211 and the second case area 213 meet, by which the resonating frequency of the antenna pattern 210 may be tuned.

The first ground 221 contacts the second case area 213 in the contact method. Specifically, the first ground 221 is placed on the lower end of the second case area 213 and grounds the second case area 213.

The first terminal 224 electrically connects the electrical feeder 223 to the circuit board. Specifically, the first terminal 224 includes area where cables can be soldered (i.e. is a cable connector), connects the circuit board through the soldered cables, and connects the electrical feeder 223 through the antenna pattern 210.

The second terminal 222 connects the first ground 221 to a second ground in a system of the electronic apparatus 100. Specifically, the second terminal 222 connects the second ground of the electronic apparatus 100 through the cables, and connects the first ground 221 to the antenna pattern 210. Meanwhile, when the case 203 with the first antenna 200 formed thereon is provided to protect a display apparatus 301, the second terminal 224 may connect the ground of the display apparatus 301.

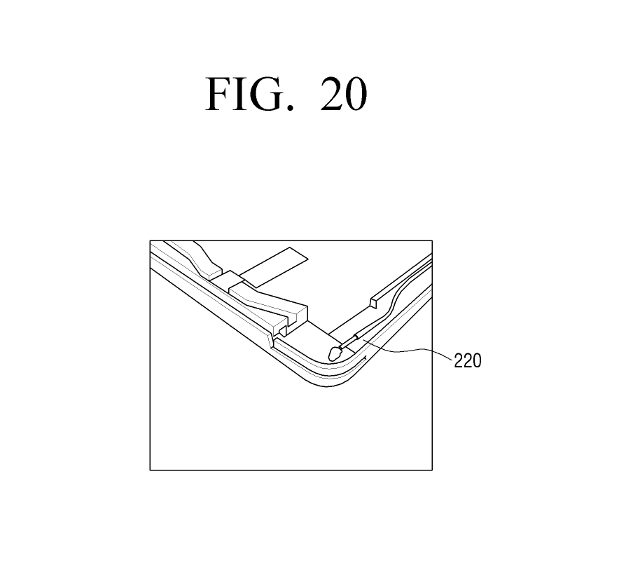

FIG. 19 illustrates a constitution of a connector 220′ according to an exemplary embodiment of the present general inventive concept, and FIG. 20 illustrates an example of implementing the connector 220′ of FIG. 19.

The connector 220′ according to the exemplary embodiment of the present general inventive concept is identical to the connector 220 according to the exemplary embodiment illustrated in FIG. 17, except for the difference that the first terminal 224′ is implemented as a cable connector. Accordingly, the electrical feeder 223, the first ground 221, and the second terminal 222 will not be repeatedly described herein.

The first terminal 224′ electrically connects the electrical feeder 223 to the circuit board. Specifically, the first terminal 224′ may include the cable connector connecting the cables, connect the circuit board through the cable connector and the cables mounted on the cable connector, and connect the electrical feeder 223 to the antenna pattern 210.

Meanwhile, although the above describes that the connector 220 or 220′ includes only one electrical feeder 223, the connector 220 or 220′ may include a plurality of electrical feeders 223 and a plurality of first terminals 224 to respectively connect the plurality of electrical feeders 223 to the circuit board, particularly when using the antenna pattern 210 according to the exemplary embodiment of the present general inventive concept.

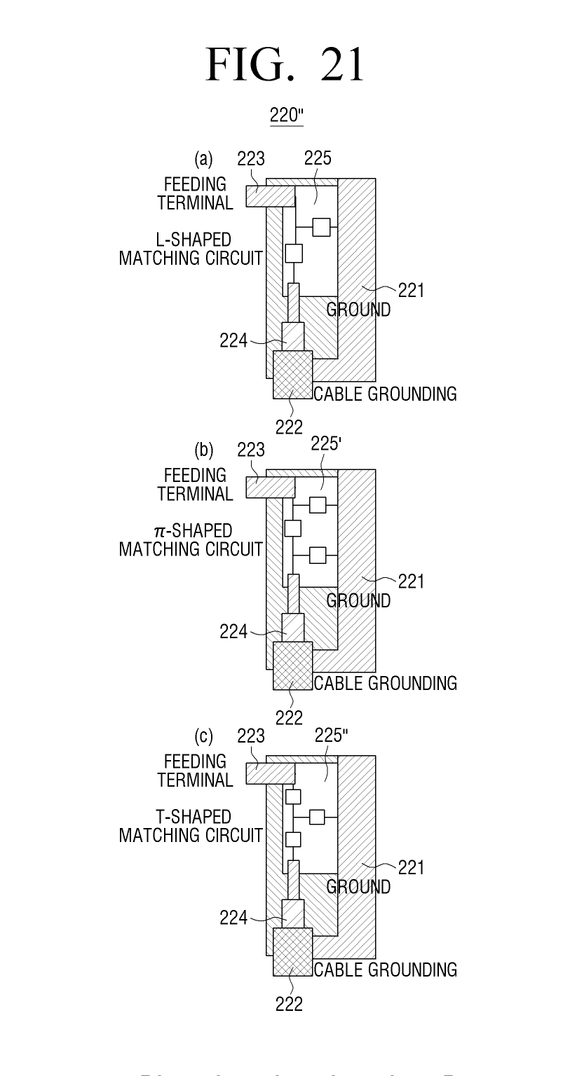

Further, although the above describes that the connector 220 or 220′ only performs a function to connect the antenna pattern 210 and the circuit board, the connector 220 or 220′ may further have additional functions. Such example will be described below by referring to FIGS. 21 to 24.

FIG. 21 illustrates a constitution of a connector 220′ according to an exemplary embodiment of the present general inventive concept. Specifically, the connector 220″ according to the exemplary embodiment has a function of matching impedance in addition to the function of the connector 220 according to the exemplary embodiment described above with reference to FIG. 17.

Referring to view (a) of FIG. 21, the connector 220 includes the electrical feeder 223, the first ground 221, the first terminal 224, the second terminal 222, and a matcher 225. Functions of the electrical feeder 223, the first ground 221, the first terminal 224 and the second terminal 222 are the same as those of constitution in FIG. 17, which will not be described herein.

The matcher 225 is placed between the electrical feeder 223 and the first terminal 224 and operates to match impedance of the antenna pattern 210. The matcher 225 may include one of a L-shaped matching circuit in view (a) of FIG. 21, a 7-shaped matching circuit (matcher 225′, illustrated in view (b) of FIG. 21), and a T-shaped matching circuit (matcher 225″, illustrated in view (c) of FIG. 21). Constitution and function of the L-shaped matching circuit, the 7-shaped matching circuit, and the T-shaped matching circuit are well known in the art, which will not be described herein.

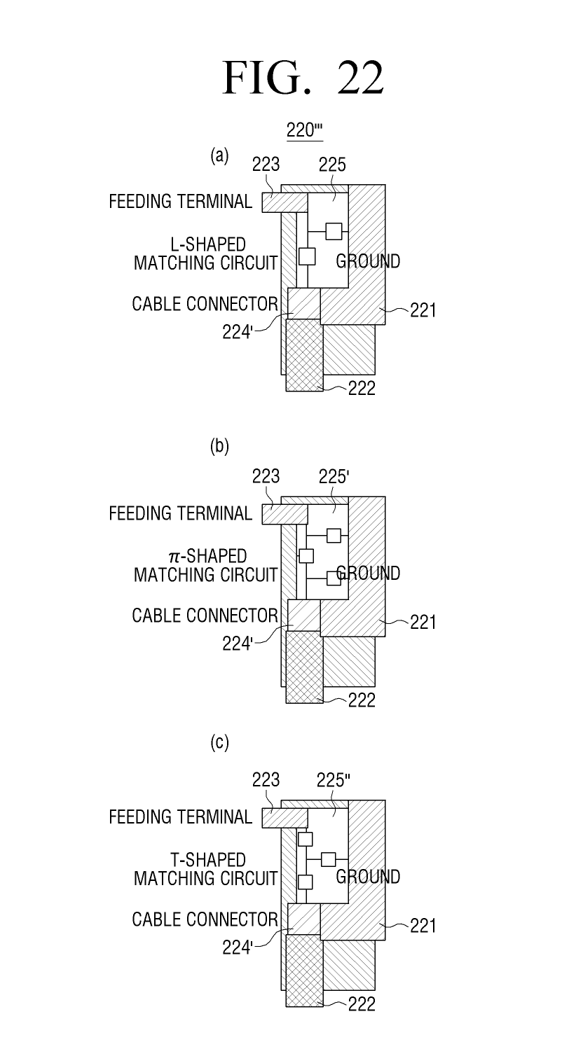

FIG. 22 illustrates a constitution of a connector 220″′ according to an exemplary embodiment of the present general inventive concept. Specifically, the connector 220″' according to the exemplary embodiment illustrated in FIG. 22 performs matching impedance in addition to the function of the connector 220′ described above with reference to FIG. 19.

Referring to view (a) of FIG. 22, the connector 220″′ includes the electrical feeder 223, the first ground 221, the first terminal 224′, the second terminal 222, and the matcher 225. Functions of the electrical feeder 223, the first ground 221, the first terminal 224′ and the second terminal 222 are the same as those of the constitution in FIG. 19, which will not be described herein.

The matcher 225 is placed between the electrical feeder 223 and the first terminal 224′ and operates to match impedance of the antenna pattern 210. The matcher 225 may include one of an L-shaped matching circuit in view (a) of FIG. 22, a 7-shaped matching circuit in view (b) of FIG. 22, and a T-shaped matching circuit in view (c) of FIG. 22. Constitution and function of the L-shaped matching circuit, the 7-shaped matching circuit, and the T-shaped matching circuit are well known in the art, which will not be described below.

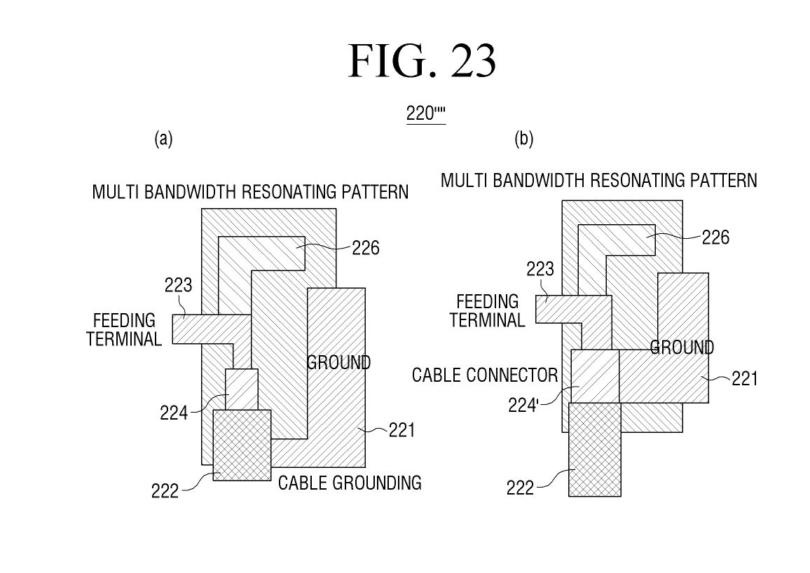

FIG. 23 illustrates a constitution of a connector 220″″ according to an exemplary embodiment of the present general inventive concept. The connector 220″″ according to the exemplary embodiment includes a second antenna pattern 226 resonating on different bandwidth from the antenna pattern 210 in addition to the function of the connector 220 or 220′ described above with reference to FIGS. 17 and 19.

Referring to FIG. 23, the connector 220″″ includes the electrical feeder 223, the first ground 221, the first terminal 224 or 224′, the second terminal 222, the matcher 225, and the second antenna pattern 226. View (a) of FIG. 23 illustrates a configuration in which the first terminal 224 is used, while view (b) of FIG. 23 illustrates a configuration in which the first terminal 224′ is used. Functions of the electrical feeder 223, the first ground 221, the first terminal 224 and 224′, and the second terminal 222 are the same as those of the constitution in FIG. 17 or FIG. 19, which will not be described below.

The second antenna pattern 226 resonates on the second bandwidth. Specifically, the second antenna pattern 226 may be formed as a metal strip pattern. Herein, the length of the metal strip pattern in the second antenna pattern 226 may be one-fourth of the wavelength on the second bandwidth.

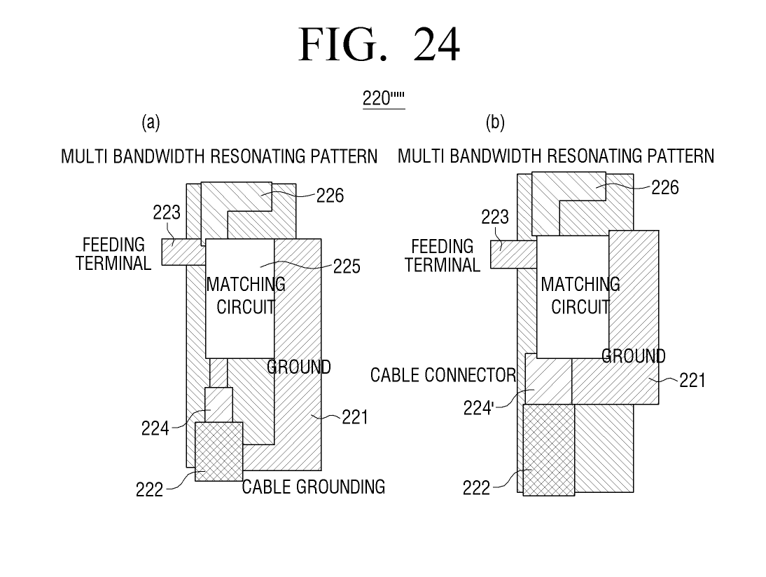

FIG. 24 illustrates a constitution of a connector 220″″′ according to an exemplary embodiment of the present general inventive concept. Specifically, the connector 220″″′ according to the exemplary embodiment includes a function of matching impedance and the second antenna pattern 226 to resonate on a different bandwidth from the antenna pattern 210, in addition to the function of the connector 220 or 220′ according to the exemplary embodiments described above with reference to FIGS. 17 and 19.

Referring to FIG. 24, the connector 220″″′ includes the electrical feeder 223, the first ground 221, the first terminal 224 or 224′, the second terminal 222, and the second antenna pattern 226. View (a) of FIG. 24 illustrates a configuration in which the first terminal 224 is used, while view (b) of FIG. 24 illustrates a configuration in which the first terminal 224′ is used. Functions of the electrical feeder 223, the first ground 221, the first terminal 224 and 224′, and the second terminal 222 are the same as those of the constitution in FIG. 17 or FIG. 19, which will not be described below.

The matcher 225 is placed between the electrical feeder 223 and the first terminal 224′ while matching impedance of the second antenna pattern 226. The matcher 225 may include one of an L-shaped matching circuit as illustrated in view (a) of FIG. 22, a 7-shaped matching circuit as illustrated in view (b) of FIG. 22, and a T-shaped matching circuit, as illustrated in view (c) of FIG. 22. Constitution and function of the L-shaped matching circuit, the 7-shaped matching circuit, and the T-shaped matching circuit are well known in the art, which will not be described below.

The second antenna pattern 226 resonates on the second bandwidth. Specifically, the second antenna pattern 226 may be formed as a metal strip pattern. Herein, the length of the metal strip pattern in the second antenna pattern 226 may be one-fourth of the wavelength on the second bandwidth.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus, comprising:
a metallic case comprising:
an antenna pattern formed on an area of the metallic case where two side surfaces of the case meet, the antenna pattern forming a slit antenna comprising:
a slit connecting one side of the antenna pattern to an open area of the metallic case; and
a circuit board configured to process signals received at the antenna pattern.

2. The electronic apparatus of claim 1, wherein the slit antenna resonates on a 2 GHz bandwidth.

3. The electronic apparatus of claim 1, wherein the slit antenna is an L-shaped slit antenna.

4. The electronic apparatus of claim 1, wherein the antenna pattern comprises:
a groove area, which is formed on the area of the metallic case where the two side surfaces of the metallic case meet, and which is a cutaway area connected at one side to the open area of the metallic case;
a first case area formed at an inner portion of the case and on one side with reference to the groove area; and
a second case area formed at an outer portion of the case and on an opposite side from the first case area with reference to the groove area.

5. The electronic apparatus of claim 4, wherein the groove area has a width of at least 1 mm.

6. The electronic apparatus of claim 4, wherein width between the groove area and the open area of the metallic case is at least 2 mm.

7. The electronic apparatus of claim 4, wherein the groove area is bent at least once.

8. The electronic apparatus of claim 7, wherein the groove area comprises:
a first groove area, which is formed in a vertical direction toward the open area of the metallic case, and which is cut so that one side thereof is connected to the open area of the metallic case; and
a second groove area, which is formed in a horizontal direction toward the first groove area, and which is cut so that one side thereof is connected to the first groove area.

9. The electronic apparatus of claim 8, wherein the second groove area has a meander shape.

10. The electronic apparatus of claim 8, wherein the length of the second groove area is one-fourth of a wavelength on a first bandwidth.

11. The electronic apparatus of claim 4, further comprising:
a connector configured to contact the antenna pattern, and to connect the antenna pattern to the circuit board.

12. The electronic apparatus of claim 11, wherein the connector is placed on an end of an area where the first case area and the second case area meet.

13. The electronic apparatus of claim 11, wherein the connector comprises:
an electrical feeder configured to contact the first case area and to electrically feed to the antenna pattern;
a first ground configured to contact the second case area;
a first terminal configured to electrically connect the electrical feeder and the circuit board; and
a second terminal configured to connect the first ground to a ground of the circuit board.

14. The electronic apparatus of claim 13, wherein the connector further comprises:
a matcher disposed between the electrical feeder and the first terminal, to match an impedance of the antenna pattern.

15. The electronic apparatus of claim 14, wherein the matcher operates to match the impedance by using one of an L-shaped matching circuit, a 7-shaped matching circuit, and a T-shaped matching circuit.

16. The electronic apparatus of claim 13, wherein the connector further comprises:
an antenna pattern configured to resonate on a second bandwidth.

17. The electronic apparatus of claim 4, further comprising:
a protector configured to fill in the groove area with an insulating material.

18. The electronic apparatus of claim 4, further comprising:
a protector configured to fill in a portion of the antenna pattern with an insulating material.

19. The electronic apparatus of claim 1, wherein the metallic case comprises a plurality of antenna patterns.

20. The electronic apparatus of claim 1, wherein the antenna pattern forms a slit antenna resonating on first and second bandwidths.

21. The electronic apparatus of claim 20, wherein the first bandwidth is a 2 GHz bandwidth, and the second bandwidth is a 5 GHz bandwidth.

22. The electronic apparatus of claim 1, wherein the antenna pattern comprises:
a third groove area, which is formed on an the area of the metallic case where the two side surfaces of the metallic case meet, and which is cut so that one side thereof is connected to the open area of the metallic case;
a fourth groove area, which is formed at an inner portion of the case and on one side with reference to the third groove area, and which is cut so that one side thereof is connected to the open area of the metallic case;
a third case area between the third groove area and the fourth groove area;
a fourth case area formed at the inner portion of the case with reference to the fourth groove area; and
a fifth case area formed at an outer portion of the case with reference to the third groove area.

23. The electronic apparatus of claim 1, wherein the metallic case is configured to protect a display apparatus.

24. The electronic apparatus of claim 23, wherein the antenna pattern is formed on at least one edge area between two edge areas on a lower end of the display apparatus.

25. A metallic case covering an electronic apparatus, the metallic case comprising:
an antenna pattern operating as a slit antenna formed on an area of the metallic case where two side surfaces of the metallic case meet.
